(19) United States
(12) Patent Application Publication
(10) Pub. No.: US 2010/0191454 A1
(43) Pub. Date: Jul. 29, 2010

(54) LOCATION BASED PERSONAL ORGANIZER

(75) Inventors: Kazuhiko Shirai, San Diego, CA (US); Yasuhiro Habara, San Diego, CA (US); Koki Iwazaki, San Marcos, CA (US); Tsuyoshi Kodera, La Jolla, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/361,800

(22) Filed: Jan. 29, 2009

(51) Int. Cl. G01C 21/36

(52) U.S. Cl. 701/201; 701/204

(57) ABSTRACT

A personal organizer automatically obtains current position and traffic information for events scheduled on a calendar in the personal organizer. This information is used in combination with event location information and map information in the personal organizer to calculate and present route and estimated time of arrival information to the scheduled event. If the ETA is later than the event time in the calendar, automatic delay notifications can be sent to contacts associated with the event.

### FIELD OF THE INVENTION

The present invention relates generally to location based computerized personal organizers.

### BACKGROUND OF THE INVENTION

Computerized personal organizers have been provided which allow a person to store contact information, and to maintain a calendar of events. Also, navigation aids have been provided that typically force a user to manually enter destination and start locations, which can be cumbersome and depending on the situation, e.g., driving to an event, a nuisance.

### SUMMARY OF THE INVENTION

As understood herein, navigation capability can be integrated with scheduled information typically contained in personal organizers to automatically generate navigation information in advance of scheduled events, relieving a person from having to remember an event and input navigation commands to obtain route and other navigation advice.

Accordingly, a personal organizer includes a processor, a tangible computer readable medium accessible to the processor and holding a calendar data structure and an address book data structure, and a portable housing holding the processor and medium. A display is on the housing for presenting information under control of the processor. The processor monitors the calendar data structure to determine when a reminder of an event is to be presented on the display. A reminder is generated by accessing a location of the event in a calendar data structure on the medium, with the processor obtaining a contact name associated with the event as indicated by the calendar data structure if no location of the event is in the calendar data structure and using the contact name as entering argument to an address book data structure to retrieve a location associated with the contact name. In such a case, the location associated with the contact name is used as the location of the event. The processor also receives a current geographic position of the personal organizer and uses the location of the event and the current geographic location of the personal organizer to obtain a route therebetween and/or directions thereto, which are presented on the personal organizer. Furthermore, the processor determines an estimated time of arrival (ETA) at the location of the event using the location of the event and the current geographic location of the personal organizer. The processor determines whether the ETA is later than a scheduled start time of the event as indicated in the calendar data structure and if it is, the processor presents a human-perceptible audio and/or visual alert on the personal organizer.

If desired the alert may include alternate route suggestions. In some implementations the processor can cause a notification automatically to be sent to a contact listed in the calendar data structure as being associated with the event indicating that a user associated with the personal organizer is late. Without limitation the notification may be sent via email, voice telephone call, short message service (SMS) text, or instant messenger. In these implementations the address book data structure can be accessed for the contact associated with the event and a notification can be sent to the contact's address as indicated in the address book data structure. The notification may further include a message indicating that a proposed new event start time is the ETA.

In example embodiments real time traffic information may be used to determine the ETA. Alternatively, wherein historical traffic information is used to determine the ETA.

In another aspect, a personal organizer automatically obtains current position and traffic information for events scheduled on a calendar in the personal organizer. This information is used in combination with event location information and map information in the personal organizer to calculate and present route and estimated time of arrival information to the scheduled event. If the ETA is later than the event time in the calendar, automatic delay notifications can be sent to contacts associated with the event.

In another aspect, a tangible computer readable storage medium bears instructions executable by a processor to receive a current geographic location of a portable electronic device, receive a location of an event, and determine an estimated time of arrival (ETA) using the current geographic location and the location of the event. The instructions also cause the processor, if the ETA is later than a scheduled start time of the event, to present a human-perceptible alert on the portable electronic device, and/or to automatically send, without user intervention, a delay notification to one or more contacts associated with the event.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example personal organizer in accordance with present principles, schematically showing internal components;

FIG. 2 is a flow chart of example calendar monitoring logic; and

FIG. 3 is a flow chart of example notification logic.

### DETAILED DESCRIPTION OF THE PREFERRED EMBODIMENT

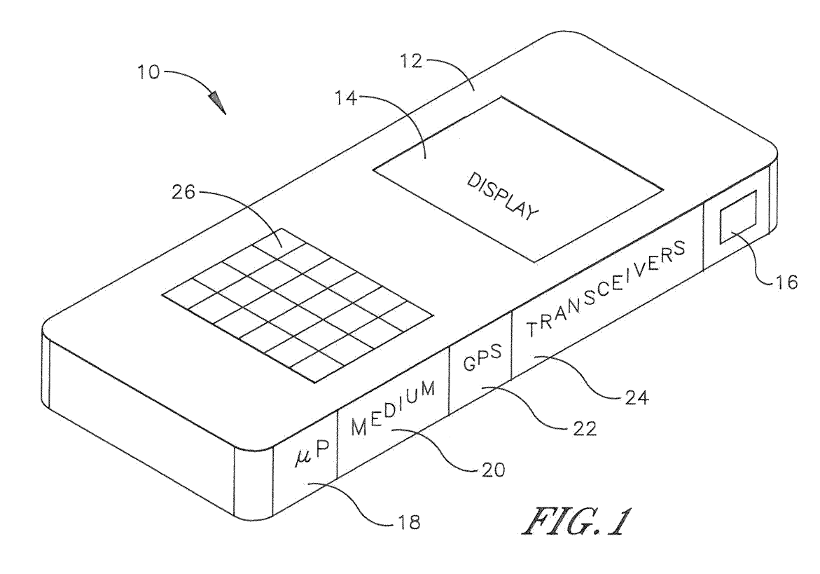

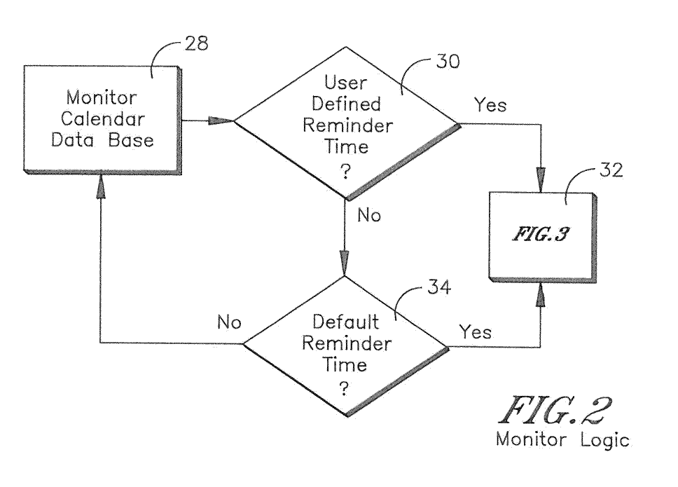

Referring initially to FIG. 1, a personal organizer 10 is shown which includes a portable lightweight housing 12 bearing a visual display 14 such as but not limited to a liquid crystal display (LCD) screen. Also, the housing 12 of the personal organizer 10 may support one or more audio speakers 16. The display 14 and speakers 16 respectively output video and audio signals from a computer processor 18 in the housing 12 and programmed in accordance with principles herein to access one or more computer readable storage media 20. The storage medium 20 may be implemented by solid state storage, disk-based storage, removable media storage, or other tangible storage. The medium 20 can store logic executable by the processor 18 as well as data including personal contact information and map information as more fully disclosed below.

Also, a geographic position receiver 22 may be included on the housing 12 and may communicate position information to the processor 18. The position receiver 22 may be implemented by a geographic position satellite (GPS) receiver as indicated in FIG. 1. Furthermore, one or more communication transceivers 24 (only one shown for clarity) may be provided on the housing 12 to communicate with the processor 18. Without limitation, the transceiver 24 may be a telephony transceiver such as a Global System for Mobile communication (GSM) transceiver, code division multiple access (CDMA) transceiver, time division multiple access (TDMA) transceiver, frequency division multiple access (FDMA) transceiver, orthogonal frequency division multiplexing (OFDM) transceiver, Bluetooth transceiver, WiFi transceiver, etc. In any case, as shown the housing 12 may also bear one or more input devices 26 such as but not limited to a keypad by which a person can input information such as contact information into the processor 18 for storage thereof on the medium 20.

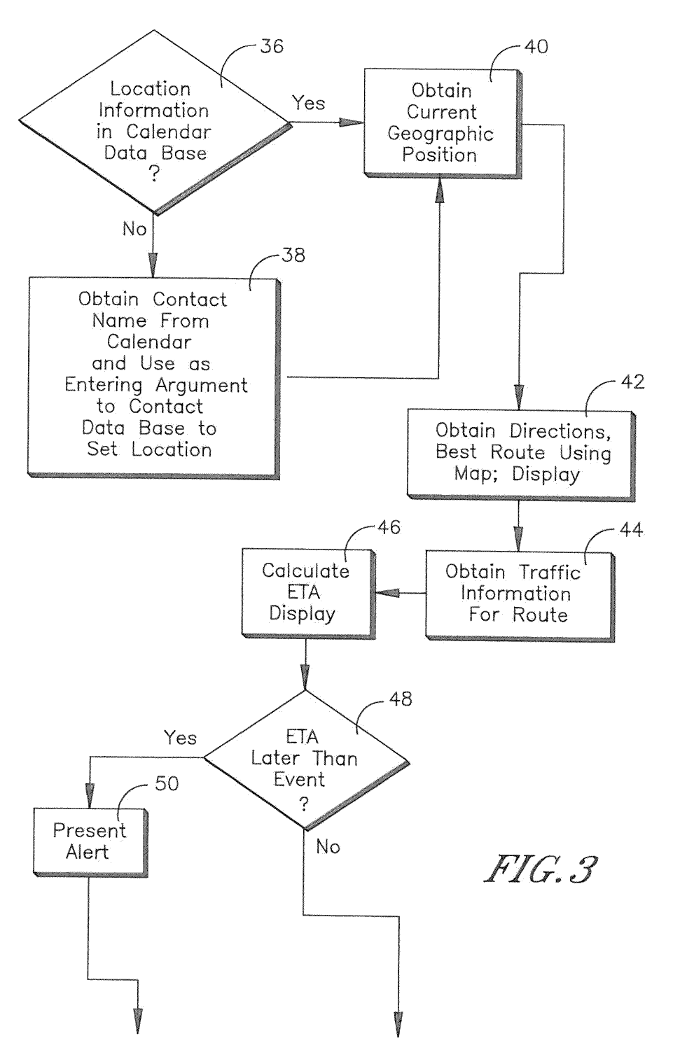

Now referring to FIG. 2, at block 28 a calendar data structure in the personal organizer 10 is monitored. The calendar data structure, which may be a table, ordered list, etc., ordinarily contains the following user-input data: scheduled events each with some or all of subject of event, event geographic location, including street address, event label, event start time, event end time, whether the event is recurring, whether an event reminder is to be generated and if how much in advance of the event, notes regarding the event, people contacts from the address book data structure (described below) who are associated with the event, and event category. More specifically, in addition to the calendar data structure the personal organizer 10 also contains an address book data structure containing one or more of the names, home and work addresses, home, work, and mobile telephone numbers, and email/message addresses of people, typically input by the user of the personal organizer 10.

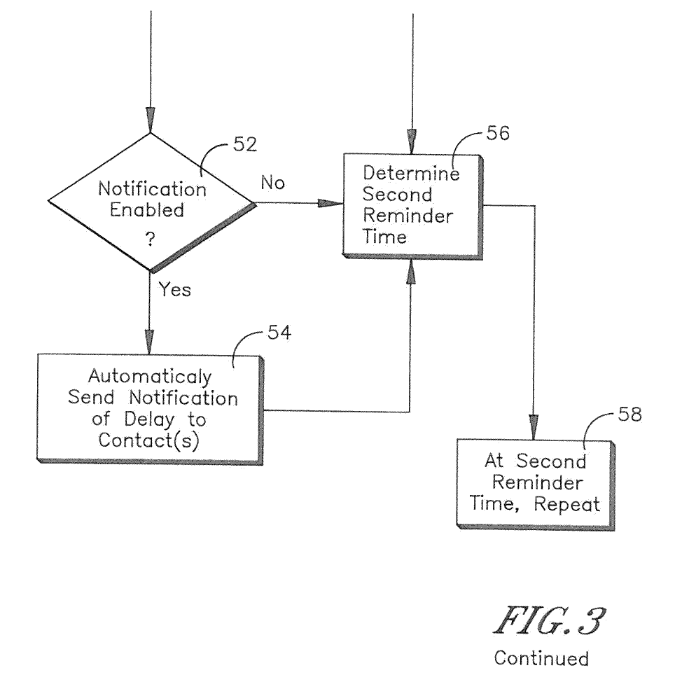

Decision diamond 30 indicates that when the monitored calendar data structure indicates that the current time is the time scheduled for a reminder of an event (also referred to herein as a “notification”) as indicated in the calendar data structure, the logic moves to FIG. 3 at block 32. In the absence of scheduled reminders, if desired the logic may move to decision diamond 34 to determine, for each scheduled future event on the calendar (or only for the “N” earliest future events) whether a reminder should be generated by default. In one implementation, a user-defined or manufacturer-defined default reminder period of “X” hours may be used, i.e., “X” hours prior to every event (alternatively, prior to every event only of a specified category), a reminder is generated in accordance with FIG. 3 regardless of whether the user has entered a reminder time in the calendar.

FIG. 3 shows the details of an example implementation of notifying a user of an upcoming event on the calendar. At decision diamond 36 it is determined whether the location of the scheduled event is in the calendar data structure. If not, the logic moves to block 38 to obtain a contact name associated with the event as indicated by the calendar and then use the contact name as entering argument to the address book data structure to retrieve a location (e.g., a physical work address) associated with the contact name.

From decision diamond 36 if the event location information was found in the calendar or from block 38 (setting the event location to be equal to the contact's physical address in the address book), the logic moves to block 40. At block 40, the current geographic position of the personal organizer 10 is obtained as indicated by the position sensor 22.

Proceeding to block 42, using the event location as a destination and the current geographic location of the personal organizer 10 as a departure location, a map data structure is accessed to obtain an optimum route between the departure and destination as well as text directions to the destination from the departure point. The map data structure may be stored locally on the medium 20 or it may be accessed on a remote server using the transceiver 24. A portion of the map with the route highlighted, along with the text directions, can be presented on the display 14.

Additionally, if desired traffic information may be obtained at block 44 for the route determined at block 42. The traffic information may be real time traffic information from a remote server that is received through the transceiver 24. Proceeding to block 46 the route characteristics, including distance and speed limits as adjusted for current traffic conditions, are used to determine an estimated time of arrival (ETA), which also may be presented on the display 14. Alternatively, if current traffic information is unavailable, travel time from the departure to the destination may be determined using just the route distance and/or route information input at the event creation in the calendar. Yet again, if current traffic information is unavailable, travel time from the departure to the destination may be determined using historical route information, e.g., route information pertaining to the same time of the previous day, or the same day of the week of the previous week.

As shown in the example logic of FIG. 3, after determining ETA if desired the logic may proceed to decision diamond 48 to determine whether the ETA is later than the scheduled start time of the event as indicated on the calendar. If it is, at block 50 an audio and/or visual alert may be presented on the speaker 16/display 14. For example, the speaker 16 may beep and/or the display 14 may present a “late” message. In some embodiments the alert may include optional action suggestions, e.g., alternate route suggestions.

If a delay notification feature has been enabled as determined at decision diamond 52, a notification is automatically sent at block 54 to every contact listed on the calendar data structure as being associated with the event for which the ETA calculated at block 46 indicates the user of the personal organizer 10 is late. To do this, the address book data structure can be accessed for each contact associated with the event and a notification can be sent to the contact's email address. Other forms of notification may include text (short message service) to the contact's telephone number, a telephone call including an automated voice call to the contact's telephone number, an instant messenger notification to the contact's IM name, etc. The user of the personal organizer 10 may be given the option to designate which notification mode and which contact address information to use globally or on a user by user basis, and/or a default mode and default address may be used. For example the default may be “always send a SMS to the contact's mobile telephone number”. The notification indicates that the user of the personal organizer 10 expects to be delayed for the event name as listed in the calendar data structure.

Furthermore, as part of the delay notification, a message indicating that the proposed new event start time is the ETA calculated at block 46 may also be included.

In some implementations when the ETA is not later than the event start time at decision diamond 48, or if notification is not enabled at decision diamond 52, or from block 54, the logic may proceed to block 56 to determine a second reminder time. For example, after the elapse of “M” hours from the first reminder, where “M” may be a default number and/or defined by the user of the organizer 10, the logic of FIG. 3 may be executed again at block 58.

Point of interest (POI) information associated with the destination location may also be looked up and presented to the user on the display 14.

While the particular LOCATION BASED PERSONAL ORGANIZER is herein shown and described in detail, it is to be understood that the subject matter which is encompassed by the present invention is limited only by the claims. For instance, while the example logic is shown in flow chart format for illustration, state logic equivalently is envisioned.

What is claimed is:

1. A personal organizer, comprising:
processor;
tangible computer readable medium accessible to the processor and holding at least a calendar data structure and an address book data structure;
portable housing holding the processor and medium;
display on the housing and presenting information under control of the processor;
the processor monitoring the calendar data structure to determine when a reminder of an event is to be presented on the display;
wherein a reminder is generated by accessing a location of the event in a calendar data structure on the medium, the processor obtaining a contact name associated with the event as indicated by the calendar data structure if no location of the event is in the calendar data structure and using the contact name as entering argument to an address book data structure to retrieve a location associated with the contact name, the location associated with the contact name being used as the location of the event;
the processor receiving a current geographic position of the personal organizer;
the processor using the location of the event and the current geographic location of the personal organizer to obtain a route therebetween and/or directions thereto, the route and/or directions being presented on the personal organizer;
the processor determining an estimated time of arrival (ETA) at the location of the event using at least in part the location of the event and the current geographic location of the personal organizer;
the processor determining whether the ETA is later than a scheduled start time of the event as indicated in the calendar data structure and if it is, presenting a human-perceptible audio and/or visual alert on the personal organizer.

2. The personal organizer of claim 1, wherein the alert includes alternate route suggestions.

3. The personal organizer of claim 1, wherein the processor causes a notification automatically to be sent to at least one contact listed in the calendar data structure as being associated with the event indicating that a user associated with the personal organizer is late.

4. The personal organizer of claim 3, wherein the address book data structure is accessed for the contact associated with the event and a notification is sent to the contact's address as indicated in the address book data structure.

5. The personal organizer of claim 3, wherein the notification includes a message indicating that a proposed new event start time is the ETA.

6. The personal organizer of claim 1, wherein real time traffic information is used to determine the ETA.

7. The personal organizer of claim 1, wherein historical traffic information is used to determine the ETA.

8. A personal organizer automatically obtaining current position information for events scheduled on a calendar in the personal organizer and using the information in combination with event location information in the personal organizer to calculate and present route and estimated time of arrival (ETA) information to the scheduled event, wherein if the ETA is later than the event time in the calendar, a delay notification automatically is sent to at least one contact associated with the event.

9. The personal organizer of claim 8, wherein if the ETA is later than the event time in the calendar an alert is presented on the personal organizer, the alert including alternate route suggestions.

10. The personal organizer of claim 9, wherein an address book data structure in the personal organizer is accessed for the contact associated with the event and a notification is sent to the contact's address as indicated in the address book data structure.

11. The personal organizer of claim 8, wherein the notification includes a message indicating that a proposed new event start time is the ETA.

12. The personal organizer of claim 8, wherein real time traffic information is used to determine the ETA.

13. The personal organizer of claim 8, wherein historical traffic information is used to determine the ETA.

14. A tangible computer readable storage medium bearing instructions executable by a processor to:
receive a current geographic location of a portable electronic device;
receive a location of an event;
determine an estimated time of arrival (ETA) using the current geographic location and the location of the event;
if the ETA is later than a scheduled start time of the event, present a human-perceptible alert on the portable electronic device, and/or automatically send, without user intervention, a delay notification to at least one contact associated with the event.

15. The medium of claim 14, wherein if the ETA is later than the scheduled start time of the event, a human-perceptible alert is presented on the portable electronic device.

16. The medium of claim 14, wherein if the ETA is later than the scheduled start time of the event, a delay notification is sent to at least one contact associated with the event.

17. The medium of claim 16, wherein the delay notification includes a message indicating that a proposed new event start time is the ETA.

18. The medium of claim 14, wherein real time traffic information is used to determine the ETA.

19. The medium of claim 14, wherein historical traffic information is used to determine the ETA.
